(19) United States
(12) Patent Application Publication
(10) Pub. No.: US 2006/0058098 A1
(43) Pub. Date: Mar. 16, 2006

(54) Telephone gaming device

(75) Inventors: Jerald C. Seelig, Absecon, NJ (US); Lawrence M. Henshaw, Pleasantville, NJ (US)

Correspondence Address: IAN F. BURNS & ASSOCIATES, P.O. BOX 71115, RENO, NV, 89570, US

(73) Assignee: Atlantic City Coin & Slot Service Company, Inc., Pleasantville, NJ (US)

(21) Appl. No.: 11/250,361

(22) Filed: Oct. 14, 2005

Related U.S. Application Data
(62) Division of application No. 10/309,590, filed on Dec. 3, 2002, now Pat. No. 6,796,110.

(51) Int. Cl. A63F 13/00

(52) U.S. Cl. 463/20

(57) ABSTRACT

A gaming system that allows several game players to play a game and to interact with each other. The gaming system includes several gaming devices. The gaming devices each have a telephone that allows a game player to place or receive a telephone call. A server is in communication with the gaming devices. The server determines a game outcome and transmits the game outcome to the gaming devices. The server also allows game players to communicate with each other using the gaming device telephone.

### CROSS REFERENCE TO RELATED AND CO-PENDING APPLICATIONS

This application is a continuation in part application of U.S. patent application Ser. No. 10/309,591, filed Dec. 3, 2004. The contents of which are herein incorporated by reference in its entirety.

### BACKGROUND OF THE INVENTION

1. Field of Invention

The present invention relates to a gaming device that allows a player to use a telephone as a part of the game.

2. Description of Related Art

Gaming Devices

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device may present the outcome of the game on a large variety of display devices, such as mechanical spinning reels or video screens.

Bonus Games

Some gaming devices award bonuses in addition to prizes that are awarded in the primary game. A bonus can be defined as an additional prize that is awarded to the player when a predefined event occurs. An example of a bonus game can be found in U.S. Pat. No. 5,848,932 issued to Adams. One of the gaming devices described in this document comprises three spinning reels and a spinning wheel bonus display. When predetermined indicia are displayed on the spinning reels of the primary game, the wheel can be activated to indicate a bonus prize. The bonus prize is awarded in addition to any prizes awarded in the primary game.

Generally, bonus prizes are offered in such games in order to increase the excitement and enjoyment experienced by players. This attracts more players to the game and encourages players to play longer. When gaming devices attract more players and the players play longer, they tend to be more commercially successful relative to other gaming devices.

Display Devices

In addition, highly visible display devices are utilized on gaming devices in order to attract players. Once players are attracted to the gaming device, they tend to play longer because the display device enhances the stimulation and excitement experienced by players. It is, therefore, desirable for gaming devices to incorporate highly visible display devices.

Display devices tend to be more successful if they are a derivation of a well-known game or theme. They are more successful because players tend to be drawn to games that they instantly recognize. Many players are reluctant to try completely new games because they must spend time to learn the new game. It is, therefore, desirable to provide display devices that are based on well-known games or themes.

Display devices also tend to be more successful if they utilize physical objects rather than simulations. Although video devices and electronic signs can be used for display devices, players are more attracted to display devices that utilize physical objects. Physical objects can be even more effective display devices if they are moveable and they are used in combination with lights and sounds.

What has long been needed is a gaming device that adds to player satisfaction and enjoyment leading to longer playing times. Another long felt need is for a gaming device that allows the game player to utilize physical objects to interact with the game while at the same time providing for a random outcome of the game.

### SUMMARY OF ONE EMBODIMENT OF THE INVENTION

Advantages of One or More Embodiments of the Present Invention

The various embodiments of the present invention may, but do not necessarily, achieve one or more of the following advantages:
provides a gaming device that adds to player satisfaction and excitement;
   provides a gaming device that allows a game player to interact with the gaming device;
   provides a gaming device that allows interaction with a physical object that may not have an impact on the outcome of the game;
   provides a gaming device that allows a game player to use a telephone during the game;
   provides a gaming device that allows a game player to select a telephone call recipient;
   provides a gaming device that generates a multiplier to provide larger prizes;
   provides a gaming device that displays the multiplier to the game player;
   provides a gaming device that can be used as a primary game or a bonus game;
   provides a gaming device that is attractive and entertaining to a game player;
   provides a gaming device that requires no human operators;
   provides a gaming device that displays images of telephone call recipients;
   provides a game network;
   allows game players to talk to each other over a telephone; and
   provides a gaming method in which a prize is determined by the number of rings to answer a telephone.

These and other advantages of the present invention may be realized by reference to other portions of the specification, claims, and abstract.

### BRIEF DESCRIPTION OF ONE EMBODIMENT OF THE PRESENT INVENTION

The present invention comprises a gaming device. The gaming device allows the game player to initiate a game sequence by placing or simulating the placement of a telephone call. A controller generates a base prize in response to receiving the telephone call. Several telephone call recipients are displayed to the game player. One of the telephone call recipients is selected to receive the telephone call. The prize is announced over the telephone to the game player by the telephone call recipient. The controller generates a multiplier. The controller multiplies the base prize by the multiplier to obtain a total prize that is awarded to the game player. Several of the gaming devices can be linked by a server in a gaming network.

In another aspect, the present invention comprises a gaming system. The gaming system includes several gaming devices. The gaming devices each have a telephone that allows a game player to place or receive a telephone call. A server is in communication with the gaming devices. The server determines a game outcome and transmits the game outcome to the gaming devices. The server also allows game players to talk to each other using the gaming device telephone.

The above description sets forth, rather broadly, the more important features of the present invention so that the detailed description of the embodiments that follow may be better understood and contributions of the present invention to the art may be better appreciated. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Embodiments of the present invention are shown in the accompanying drawings wherein:

FIG. 1 is substantially a front view of the gaming device of the present invention.

FIG. 2 is substantially a schematic diagram of the gaming device of the present invention.

FIG. 3 is substantially a front view of the gaming device of the present invention utilizing a video display.

FIG. 4 is substantially a flow chart of the operation of the gaming device of the present invention.

FIG. 5 is substantially a front view of the gaming device of FIG. 1 used as a bonus game in conjunction with a primary game.

FIG. 6 is substantially a schematic diagram of the bonus gaming device of FIG. 5.

FIG. 7 is substantially a flow chart of the operation of the bonus game embodiment of FIG. 5.

FIG. 8 is substantially a schematic diagram of a network of the gaming devices of FIG. 1 linked by a server.

FIG. 9 is substantially a flow chart of a method of operating the gaming device of the present invention

FIG. 10 is substantially a flow chart of another method of operating the gaming device of the present invention

FIG. 11 is substantially a flow chart of an additional method of operating the gaming device of the present invention

FIG. 12 is substantially a flow chart of still another method of operating the gaming device of the present invention

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Gaming Device

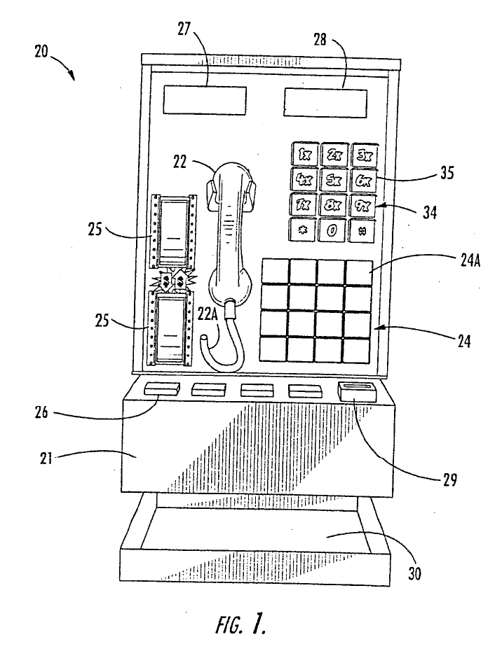

As seen in FIG. 1, the present invention comprises a gaming device, generally indicated by reference number 20. Gaming device 20 comprises a chassis 21, a telephone 22, a telephone recipient display 24, spinning reels 25, selector buttons 26, a multiplier display 34, a base award or prize display 27, a total award or prize display 28, a coin slot or card reader 29 for accepting wagers and a coin dispenser 30 for awarding prizes.

In order to play gaming device 20, a game player deposits a wager into coin slot 29. Other forms of currency, vouchers or credit may be used in conjunction with gaming device 20 as is well known in the art. Gaming device 20 may also include a virtual bank to store credits that would be played on gaming device 20. The game player then can depress one of buttons 26 or pick up telephone 22 to start a telephone call. If the player depresses button 26 to start the call, telephone 22 can be fixed in place or can be an image of a telephone. If the player picks up telephone 22, then telephone 22 can be a conventional telephone such as is found in a telephone booth. Telephone 22 can also be other types of telephones such as a wireless phone or a table phone. Telephone 22 can be electrically and mechanically attached to gaming device 20 by a shielded cable or telephone cord 22A. The telephone is supplied with a dial tone like a regular telephone.

Telephone recipient display 24 shows several images 24A of people or telephone call recipients that may be called on telephone 22. For example, images 24A can be a stockbroker, a banker, a loan officer, a policeman, a lawyer, a doctor, a movie star or a government official. Preferably, gaming device 20 decides which of images 24A is to be called. Alternatively, the game player may be allowed to choose which of images 24A is called using selector buttons 26. Display 24 could also be a touch screen display in which the game player touches the image of the person who is desired to be called.

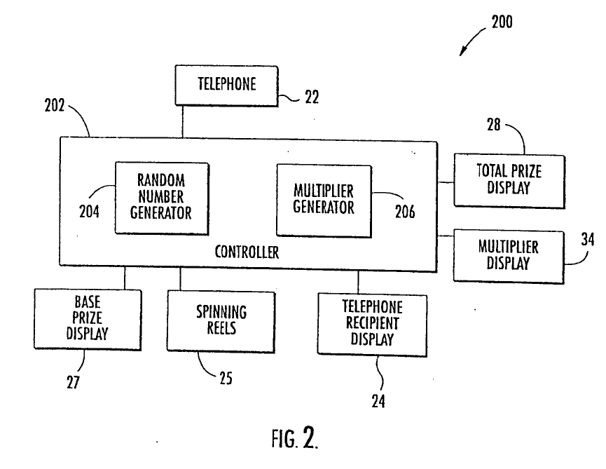

Gaming device 20 decides which of images 24A is to be called by using a pair of spinning reels 25. Starting the telephone call causes the two spinning reels 25 to begin to spin. Reels 25 have indicia thereon of images 24A, i.e. the stockbroker, banker, loan officer, policeman, lawyer, doctor, movie star or government official. The two spinning reels 25 will stop on a common image 24A indicating the selected telephone call recipient. The spinning reels are controlled by a controller 202 (see FIG. 2).

The telephone includes a speaker (not shown) to allow the game player to hear telephone sounds or voices. The telephone can ring if desired. The selected telephone call recipient announces on the telephone, to the player, a base award or prize that they have won. In addition to announcing the base prize, the telephone call recipient may provide commentary, jokes, music or other audio forms of entertainment to the game player. The base award is shown to the game player on base award display 27. Base award display 27 can be a conventional meter or a video display.

After the base award has been determined, gaming device 20 initiates a second phone call. A second phone number is dialed. A multiplier display or telephone keypad 34 has several keys 35 that light up to indicate the numbers that are dialed. Keys 35 have indicia thereon that indicates a multiplier. Keys 35 are shown with indicia of 1× through 10×. The last digit of the telephone number dialed remains lit to indicate the selected multiplier on one of keys 35. The selected multiplier can be announced over the telephone 22 to the game player.

The multiplier is multiplied by the base award to obtain a total award or prize. The total award is shown to the player on total prize display 28. If desired, the total award can be announced over the telephone 22 to the game player. The use of a multiplier allows for larger prizes to be awarded. The total prize is then awarded to the player by coin dispenser 30. If the last digit of the phone number dialed is zero, gaming device 20 may award a consolation prize or select a multiplier other than zero to be multiplied by the base award.

Turning now to FIG. 2, a schematic diagram 200 of the gaming device 20 of the present invention is shown. Gaming device 20 has a controller or processor 202. Controller 202 comprises a random number generator 204 and a multiplier generator 206. The controller 202 controls communication with telephone 22. Controller 202 is in communication with telephone recipient display 24, multiplier display 34, base award or prize display 27, spinning reels 25 and total award or prize display 28. Controller 202 drives the displays and spinning reels. Controller 202 may be a single processor or a processor board.

The random number generator 204 produces a random or pseudo random number for each game. An award prize of the game may be determined by comparing the random number to a table of outcomes stored in a memory and accessed by random number generator 204. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. It is recognized that gaming device 20 may operate in many other ways and still achieve the objects of the present invention.

Controller 202 receives the base award from random number generator 204. The base award is displayed on display 27. At this point, the multiplier generator 206 generates a multiplier. The multiplier is shown to the player on display 34. Controller 202 then calculates a total prize or award. The total award is equal to the base award multiplied by the multiplier. For example, if the base award is 5 and the multiplier is 10. The total award or prize would be 50. The total prize can be awarded in coins, dollars or credits. The total prize is shown on total prize display 28. The amount of the prize may be added to the player's credit meter or the prize may be dispensed from coin dispenser 30.

Video Display

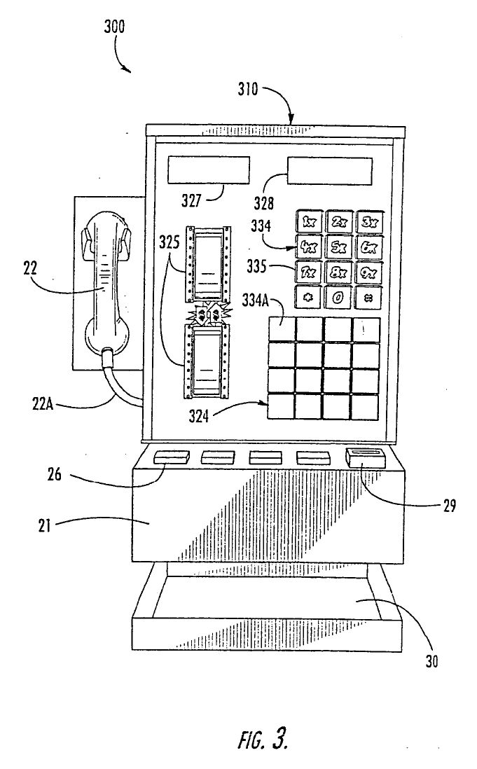

Referring to FIG. 3, a gaming device 300 is shown. Gaming device 300 comprises a video display 310, telephone 22 and chassis 21. Gaming device 300 is similar to gaming device 20 except that video display 310 replaces spinning reels 25, telephone recipient display 24, multiplier display 34, base award or prize display 27, and total award or prize display 28.

Video display 310 presents an image of the spinning reels 325, an image of telephone recipient display 324, an image of multiplier display 334, an image of base award or prize display 327, and an image of total award or prize display 328. Video display 310 may be any of a large number of display devices that are well known in the art. For example, video display 310 may be a cathode ray tube of a type that is used with many personal computers.

Video display 310 is in communication with controller or processor 202. Controller 202 transmits messages to video display 310 to request the display to produce different displays. For example, controller 202 may send a signal to video display 310 to spin reels 325 in response to a wager being placed or on a telephone call recipient being selected with selector button 26. The operation of gaming device 300 is the essentially the same as for gaming device 20.

Video display 310 may comprise a video controller (not shown) that drives the display device to present various displays. Many different well-known video controllers may be used. Software and data used to produce different presentations may be stored on the video controller in non-volatile memory, such as compact disks, magnetic disk drives, or erasable programmable read only memory (EPROM). Video display 310 may display other information in graphic and text form, such as instructions on how to use the gaming device. Speakers may also be provided for presenting audio information, such as sound effects or music when a prize is won.

This embodiment has the advantage of reducing maintenance because the moving parts of a mechanical display are eliminated. This embodiment also provides greater flexibility because many different kinds of presentations may be displayed on the video display 310.

Flow Chart

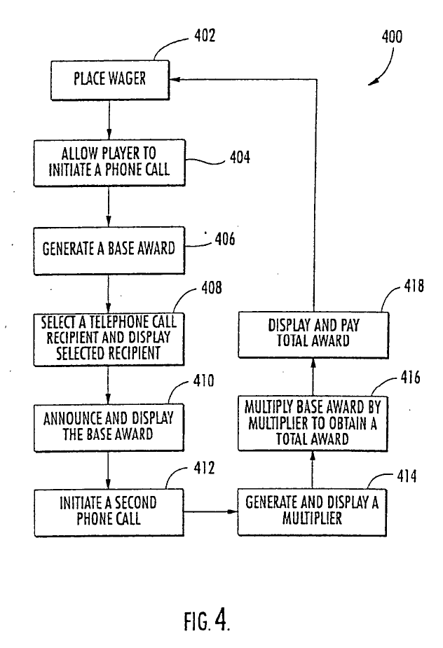

Turning now to FIG. 4, a flowchart 400 of the operation of the gaming device 20 of the present invention is shown. The method includes allowing a game player to place a wager at step 402. Next, at step 404, the player is allowed to initiate a telephone call by depressing one of buttons 26 or lifting telephone 22. A base award or prize is generated at step 406 by controller 202. The base award is preferably randomly generated. At step 408, a telephone call recipient is selected using spinning reels 25, displayed to the game player and called. The selection of the telephone call recipient may be made by the game player or it may be generated by controller 202. The selected telephone call recipient announces to the game player the base award or prize at step 410. Next, gaming device 20 makes a second telephone call to a second telephone number at step 412. At step 414, a multiplier is generated and displayed to the game player. Preferably, the multiplier is the last digit of the second telephone number. The multiplier is multiplied by the base award to obtain a total award at step 416. Next, at step 418, the total award or prize is displayed and paid to the game player. Preferably, the prize is awarded in the form of credits that are added to a virtual bank. The game then returns to step 402 to allow the game player to play the game again by placing another wager. The method of flowchart 400 can provide a game player with an enjoyable gaming experience in which they are able to participate in the game using an object such as a telephone that does not influence the outcome of the game.

Bonus Game

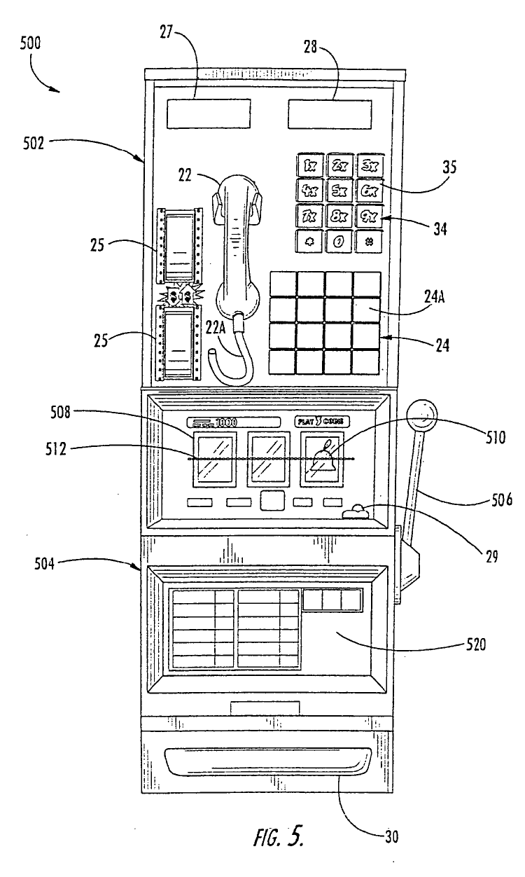

As seen in FIG. 5, the present invention can also be used as a bonus game. Bonus gaming device 500 comprises a bonus game 502 mounted on top of a primary game 504. Primary game 504 may be any of a large number of devices that are adapted to allow players to play a game such as a slot machine. Bonus game 502 is similar in structure and operation to game apparatus 20 of FIG. 1.

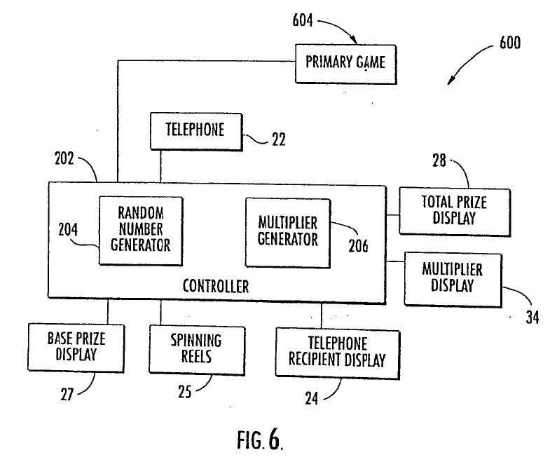

Primary game 504 comprises lever 506, rotating reels 508, payline 512, display 520, coin acceptor 29 and coin dispenser 30. Lever 506 is used by a player to start the game after a wager has been placed in coin acceptor 29. Game 504 here is shown as a conventional rotating reel type slot machine. Rotating reels 508 have a bonus symbol 510. When bonus symbol 510 lines up on payline 512, a bonus-qualifying event has occurred and the bonus game 502 is started. Controller 202 (FIG. 6) is adapted to detect when a bonus-activating event occurs in primary game 504. This may be accomplished by primary game 504 transmitting a signal to controller 202 that a bonus event has occurred. In another embodiment, one or more sensors may be provided for determining if a bonus-activating event has occurred. For example, sensors may sense the positions of the reels on primary game 504. Sensors may also be provided external to primary game 504 to detect external bonus-activating events. Display 520 shows the prizes won from game play on primary game 504.

Turning now to FIG. 6, a schematic diagram 600 of the bonus gaming device 500 of the present invention is shown. Gaming device 500 has a controller or processor 202. Controller 202 comprises a random number generator 204 and a multiplier generator 206. The controller 202 controls communications with telephone 22. Controller 202 is in communication with telephone recipient display 24, multiplier display 34, base award or prize display 27, spinning reels 25, total award or prize display 28 and primary game 504. Controller 202 drives the displays and spinning reels. Controller 202 may be a single processor or a processor board.

Bonus gaming device 500 may also be capable of producing a bonus-activating event. This event may be many different types of events. For example, a bonus-activating event may comprise obtaining a particular combination of symbols. Furthermore, a bonus-activating event may occur when a player accumulates a number of symbols or prizes over a number of separate game plays. For example, a bonus-activating event may occur when the player obtains three special symbols during a period of time. The bonus-activating event may be based on an external event. For example, a bonus-activating event may occur when a group of players obtain a certain result.

When controller 202 detects a bonus-activating event, it begins a bonus sequence by activating bonus game 502. Bonus game 502 is played in the same manner as for game apparatus 20 of FIG. 1. The game places a telephone call to a telephone call recipient who announces a base prize to the player. The base prize is shown on display 27. Bonus game 502 also places a second phone call to obtain a multiplier. The multiplier is shown on display 34. A total award is calculated, displayed on display 28 and paid with coin dispenser 30.

Bonus Game Flow Chart

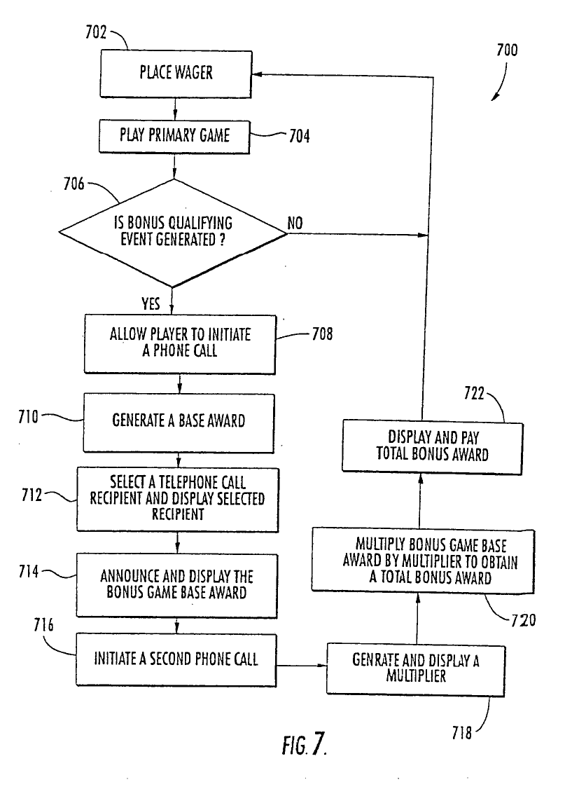

Turning now to FIG. 7, a flowchart 700 of the operation of the bonus gaming device 500 is shown. The method includes allowing a game player to place a wager at step 702. At step 704, the game player is allowed to play a primary game 504. Game 504 can be one of many games such as a conventional slot machine. Primary game 504 can generate a bonus qualifying event or signal. At decision step 706, a bonus-qualifying event is checked to see if it has occurred. If the bonus-qualifying event has not occurred, the game loops back to step 702 to allow the game player to place another wager and play primary game 504. The primary game 504 continues until the bonus-qualifying event occurs. If the bonus-qualifying event has occurred, the game moves to step 708. At step 708, bonus game 502 is activated and the player is allowed to initiate a telephone call by depressing one of buttons 26 or lifting telephone 22. A base award or prize is generated at step 710 by controller 202. The base award is preferably randomly generated. At step 712, a telephone call recipient is selected using spinning reels 25, displayed to the game player and called. The selection of the telephone call recipient may be made by the game player or it may be generated by controller 202. The selected telephone call recipient announces to the game player the base award or prize at step 714. Next, bonus gaming device 502 makes a second telephone call to a second telephone number at step 716. At step 718, a multiplier is generated and displayed to the game player. Preferably, the multiplier is the last digit of the second telephone number. The multiplier is multiplied by the base award to obtain a total award at step 720. Next, at step 722, the total award or prize is displayed and paid to the game player. Preferably, the prize is awarded in the form of credits that are added to a virtual bank. The game then returns to step 702 to allow the game player to play the game again by placing another wager. The method of flowchart 700 provides a game player with an enjoyable bonus gaming experience in which they are able to participate in the game using a physical object such as a telephone that allows the game to have a randomly generated outcome.

Gaming Network Embodiment

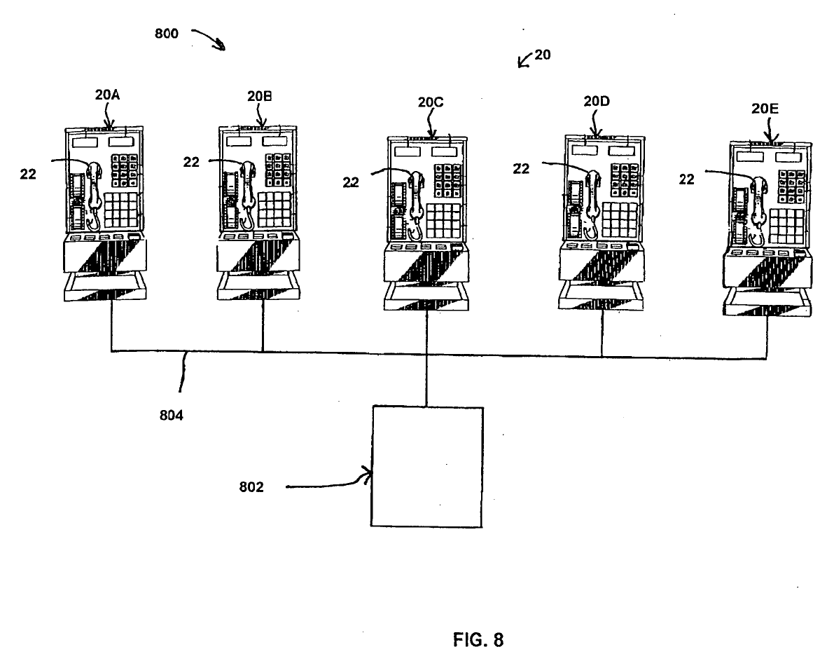

Referring now to FIG. 8, a gaming network 800 of several gaming devices 20 including 20A, 20B, 20C, 20D and 20E with a telephone 22 are shown connected together. Network 800 includes gaming devices 20A-E that are connected to a server 802 by an electrical cable 804. Server 802 can be a conventional computer server or game control computer system. Electrical cable 804 can be a wide variety of cables such as Ethernet or local area network cables. Alternatively, gaming devices 20 could be connected to server 802 using wireless communications. Server 802 facilitates communication between gaming devices 20. While five gaming devices 20 were shown in communication with server 802, more or fewer gaming devices 20 could be utilized.

Gaming device 20 can request a game outcome from server 802. Server 802 can determine a game outcome and transmit the game outcome to one or more of gaming devices 20. Server 802 can control the determination of any game outcome or prize. Gaming device 20 can announce the game outcome using telephone 22 or on a display.

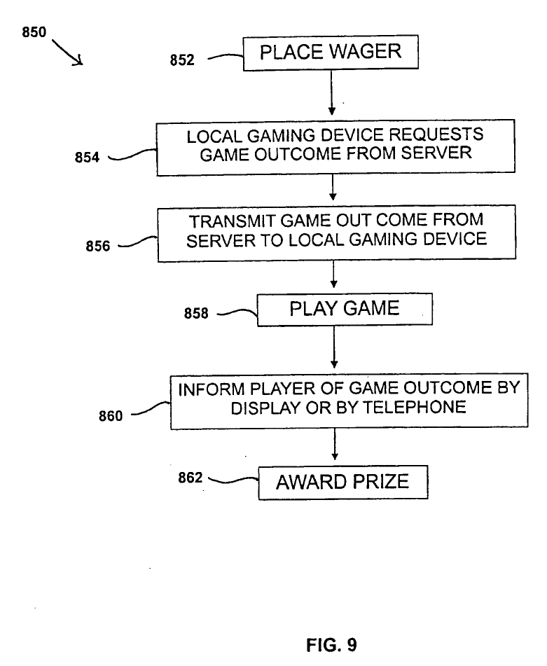

Turning now to FIG. 9 a flowchart or gaming method 850 of the operation of game network 800 is shown. Method 850 includes allowing a game player to place a wager at step 852. At step 854, gaming device 20 requests a game outcome from server 802. At step 856, server 802 transmits a game outcome to gaming device 20. Next, at step 858, a game player is allowed to play gaming device 20. The game player is informed either by telephone 22 or a display of the game outcome at step 860. Any prizes are awarded at step 862.

Server 802 can also administer a progressive jackpot. A portion of each wager placed on gaming device 20 is contributed to a progressive jackpot. Server 802 can select a game outcome for gaming device 20 that can be at least a portion of the progressive jackpot. The winning of a progressive jackpot can be announced over telephone 22.

In a progressive jackpot system, several interconnected gaming machines each contribute a portion of the wagers received by the gaming machine to a progressive jackpot. Because several gaming machines contribute to the progressive jackpot, the jackpot can increase to a large amount. Typically a game player places a wager and plays a game at the interconnected gaming machines. The progressive jackpot is awarded when a player at one of the interconnected gaming machines obtains a predetermined jackpot outcome in the game as determined by server 802. The server can compute the amount of the progressive jackpot by adding a predetermined percentage of each wager made at each gaming machine to the progressive jackpot. The jackpot is paid when a player at one of the gaming machines obtains a jackpot-winning outcome. The jackpot can be shared among all game players or the jackpot can be awarded to only one game player.

In another embodiment, server 802 can facilitate communication with other game players playing gaming devices 20 on network 800. For example, if a game player qualifies for a game playing event, the player may be allowed to use gaming device 20 to talk to other game players that are also playing on gaming network 800. The game players would use telephone 22 in order to communicate with each other. The game player may be allowed to select the other game player that they call or talk to or server 802 can select which game player is called. For example, a game player playing gaming device 20B may place a telephone call to the game player playing gaming device 20D. This manner of game play adds additional excitement to the gaming experience as it allows fellow game players the opportunity to meet and interact with each other in a manner that is facilitated by the use of gaming network 800.

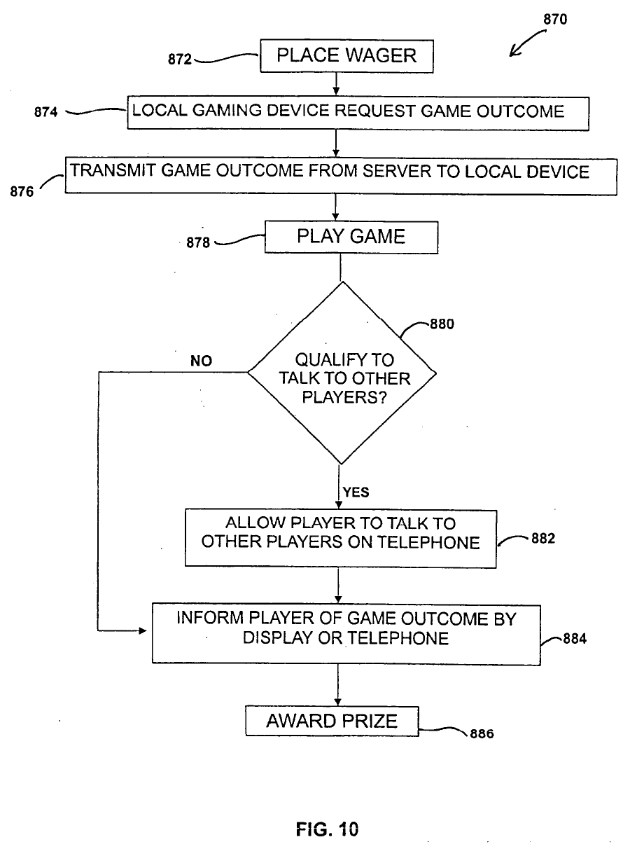

Turning now to FIG. 10 another flowchart or gaming method 870 of the operation of game network 800 is shown. Method 870 includes allowing a game player to place a wager at step 872. At step 874, one of the gaming devices 20 requests a game outcome from server 802. At step 876, server 802 transmits a game outcome to one of gaming devices 20. Next, at step 878, a game player is allowed to play gaming device 20. If the game player qualifies to talk to other game players at decision 880, method 870 proceeds to step 882 where the game player is allowed to talk with other game players using telephone 22. The game player is informed either by telephone 22 or a display of the game outcome at step 884. If the game player does not qualify to talk to other game players at decision 880, method 870 proceeds to step 884, where the game player is informed of the game outcome. Any prizes are awarded at step 886.

In another embodiment, server 802 can allow a game player to place a telephone call to another gaming device if they qualify. If another person answers the telephone call in less than pre-determined number of rings, the game player is awarded a prize. Server 802 may select the gaming device to be called or the game player may be allowed to select the gaming device to be called. The gaming device that is called may be in play by a game player or may be idle. If the gaming device is idle, the telephone may be answered by anyone walking by. If no one answers the phone within the pre-determined number of rings, no prize or a reduced prize may be awarded. Alternatively, the prize may be proportional to the number or rings that occur. This manner of game play adds additional excitement to the gaming experience as it allows the game player to watch fellow game players as they answer the ringing phone.

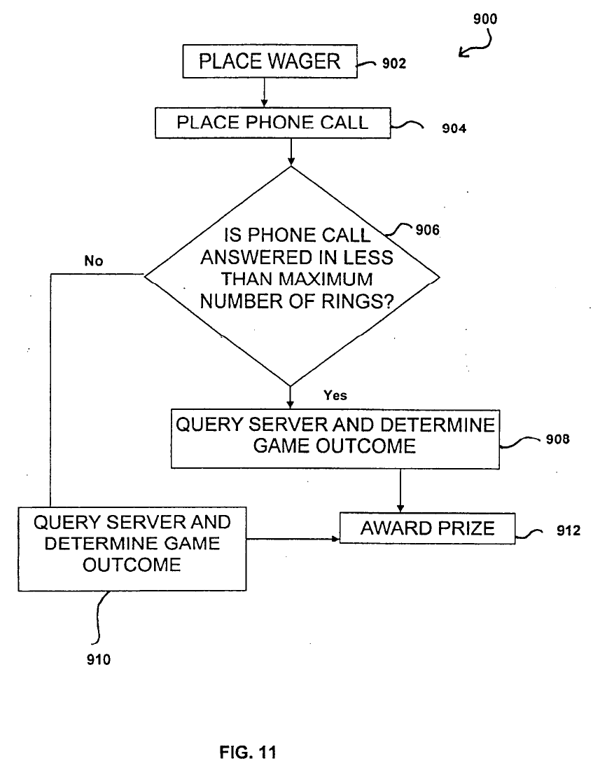

Turning now to FIG. 11 a flowchart or gaming method 900 of the operation of game network 800 is shown. Method 900 includes allowing a game player to place a wager at step 902. At step 904, the game player, if they qualify, is allowed to place a telephone call to another game player on network 800. If the telephone call is answered in less than a pre-determined number of rings, method 900 proceeds to step 908 where server 802 is informed of the number of rings and is queried for a game outcome. The game outcome can be proportional to the number of rings. If the telephone call is answered in more than a pre-determined number of rings, method 900 proceeds to step 910 where server 802 informed of the number of rings and is queried for a game outcome. Any prizes are awarded at step 912.

In another embodiment, server 802 can store or maintain a library of images of telephone call recipients. The images can include still and video images. For example, the images may include pictures or video of famous persons, celebrities, movie stars or musicians. When a game player qualifies to place a telephone call to another gaming device, server 802 can transmit images to an individual gaming device 20 and display the images on display 24. In this manner, the game player may be presented with the illusion that they will be talking with a famous person or celebrity.

Similarly, server 802 can store or maintain a library of audio of telephone call recipients. For example, the audio may include the voices of famous persons, celebrities or musicians. The audio may be portions of songs or movies. When a game player qualifies to place a telephone call to another gaming device, server 802 can transmit images and audio to an individual gaming device 20. In this manner, the game player may be presented with the illusion that they are talking with a famous person or celebrity.

Server 802 may include a number of storage devices that are well known in the art and configured to store the information. For example, the storage device may include hard disk drive or optical disks. Furthermore, server 802 may obtain data from other devices that are communicated over a computer network or other communication device.

One of the advantages of providing the game discussed above is to increase the excitement and enjoyment of playing the gaming device. Not only is the game entertaining to view, but it also increases the excitement and enjoyment experienced by a game player.

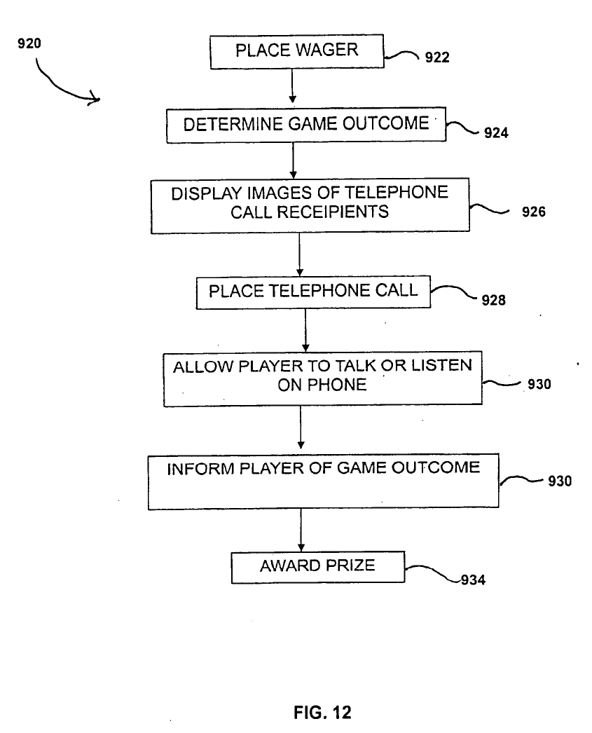

Turning now to FIG. 12 a flowchart or gaming method 920 of the operation of game network 800 is shown. Method 920 includes allowing a game player to place a wager at step 922. At step 924, the game outcome is determined by server 802. At step 926, images of at least one telephone call recipient is displayed on display 24. The images can include a video presentation. At step 928, the game player is allowed to place a telephone call on network 800. At step 930, the game player is allowed to talk or listen on the telephone. Audio and music can be presented to the game player over the telephone at step 930. The game player is informed of the game outcome at step 932. Any prizes are awarded at step 934.

While, the methods shown were described in a certain order, it is recognized that the order of the steps of the methods could be interchanged or switched and operate as a gaming network.

### CONCLUSION

It can now be seen that the present invention provides a gaming device that allows a game player to utilize a telephone to receive prize information. The present invention provides a gaming device that allows the game player to participate in the selection of a prize announcer while at the same time not having an effect on the game outcome. The present invention provides a gaming network that allows a game player to interact with other game players through the use of a telephone.

Although the description above contains many specifications, these should not be construed as limiting the scope of the invention but as merely providing illustrations of some of the present embodiments of this invention. Thus, the scope of the invention should be determined by the appended claims and their legal equivalents rather than by the examples given.

What is claimed is:

1. A gaming system, comprising:
a plurality of gaming devices, the gaming devices each having a telephone adapted to allow a game player to place or receive at least one telephone call; and
a server in communication with at least one of the plurality of gaming devices, the server adapted to determine at least one game outcome and to transmit the at least one game outcome to at least one of the gaming devices.

2. The gaming system according to claim 1, wherein the server controls a progressive jackpot, the game outcome being at least a portion of the progressive jackpot.

3. The gaming system according to claim 1, wherein the server facilitates audible communication between at least two game players using the telephone.

4. The gaming system according to claim 3, wherein the server determines which gaming device receives a telephone call.

5. The gaming system according to claim 3, wherein the game player is allowed to choose which gaming device receives a telephone call.

6. The gaming system according to claim 1 wherein the gaming device includes a video display.

7. The gaming system according to claim 6 wherein the server is adapted to store a plurality of images of telephone call recipients.

8. The gaming system according to claim 7 wherein at least one of the images is displayed on the video display.

9. A method of playing a game comprising:
allowing a player to place a wager and play a game on a first gaming device;
allowing the player to place at least one telephone call on a first telephone associated with the first gaming device to a second telephone associated with a second gaming device;
causing the second telephone to ring;
monitoring a number of times the second telephone rings before the second telephone is answered;
determining a prize at least in part by the number of times the second telephone rings before the second telephone is answered; and
awarding the prize to the player.

10. The method according to claim 10, wherein a server facilitates communication between the first and second gaming devices.

11. The method according to claim 10, further comprising:
providing a plurality of gaming devices, the plurality of gaming devices including the first and second gaming device; and
allowing the game player to choose the second gaming device.

12. The method according to claim 10, wherein the game player is allowed to talk to a telephone call recipient on the second gaming device telephone.

13. A method of playing a game comprising:
allowing a player to place a wager and play a game on a first gaming device in communication with a plurality of gaming devices;
if a predetermined event occurs, allowing the player to make a telephone call on a telephone associated with the first gaming device to a telephone associated with at least one of the plurality of gaming devices; and
awarding a prize to the game player.

14. The method according to claim 13, wherein the player is allowed to talk to a telephone call recipient.

15. The method according to claim 13, wherein a server facilitates communication between the first gaming device and the at least one of the plurality of gaming devices.

16. The method according to claim 13, wherein the prize is at least a portion of a progressive jackpot.

17. The method according to claim 13, wherein the game player is allowed to choose the at least one gaming device to receive a telephone call.

18. The method according to claim 15, wherein the server determines the at least one gaming device to receive a telephone call.

19. A gaming system, comprising:
a first gaming device having a first telephone;
a second gaming device having a second telephone;
a server in communication with the first and second telephones, the server facilitating communication between the first and second telephones, the server further adapted to determine a game outcome and to allow at least one of the gaming devices to award a prize.

20. The gaming system according to claim 19, wherein the server allows a game player to talk to a telephone call recipient.

21. The gaming system according to claim 19 wherein the gaming devices include a video display.

22. The gaming system according to claim 21 wherein the server is adapted to store a plurality of images of telephone call recipients and to display at least one of the images on the video display.
